(19) United States
(12) Patent Application Publication
(10) Pub. No.: US 2012/0278218 A1
(43) Pub. Date: Nov. 1, 2012

(54) Ascertaining market value through a competitive valuation process

(76) Inventor: Jeffery Duston Josephsen, Bellevue, WA (US)

(21) Appl. No.: 13/543,826

(22) Filed: Jul. 7, 2012

Related U.S. Application Data
(63) Continuation-in-part of application No. 12/789,407, filed on May 27, 2010.

(51) Int. Cl. G06Q 40/00

(52) U.S. Cl. 705/35

(57) ABSTRACT

System and method are provided for analyzing the value of a subject. This is accomplished through a competitive environment wherein Sources of Valuation are compensated according to the proximity of each provided valuation to a central valuation computed from the estimates of the group. From these Valuations a value is computed for the specific subject. The compensation motivates the Sources of Valuation, to compete in giving valuations which will be closest to the center of what a group of professional Sources of Valuations might provide. These sources will likely find that this is accomplished by competing to be more accurate than their competitors. This competition towards centrality finds synergy in creating an altogether more accurate system of valuing assets, liabilities, or other subjects, than that of tradition or computer perceived methods.

This application is a Continuation-in-Part of application Ser. No. 12/789,407 filed on May 27, 2010 for Ascertaining market value through a competitive valuation process which is incorporated herein by reference.

This disclosure concerns ascertaining market value through a competitive valuation process.

### BACKGROUND

There are many methods and systems for calculating the value of various subjects.

Techniques exist for valuing real property which include the Uniform Standards of Professional Appraisal Practice Act, and the Home Valuation Code of Conduct.

Techniques exist for valuing business enterprises based upon the Generally Accepted Accounting Principles (GAAP). These take into account the expected cash flow and risk associated with the future of that cash flow. Occasionally, other factors are also included such as the potential growth of a marketplace, competitive advantages, public good will and elasticity of employee morale.

Techniques of valuing intellectual property are currently lacking a generally accepted standardized approach.

Techniques for reviewing employees and salaries include yearend review and otherwise lack a generally accepted standardized approach.

Techniques for estimating budgets and forecasts exist within the GAAP.

### SUMMARY

There are a diversity of Techniques for calculating the value of various subjects. The instant application allows for the valuation of assets, liabilities, or other subjects. This valuation may be very accurate because within the system and method of the instant application Sources of Valuation each participate in a competition to provide a more central valuation estimate than their competitors. This technique may extend legitimacy to valuations in a diversity of industries, especially those lacking a centralizing method.

### FIGURES

### Brief Description

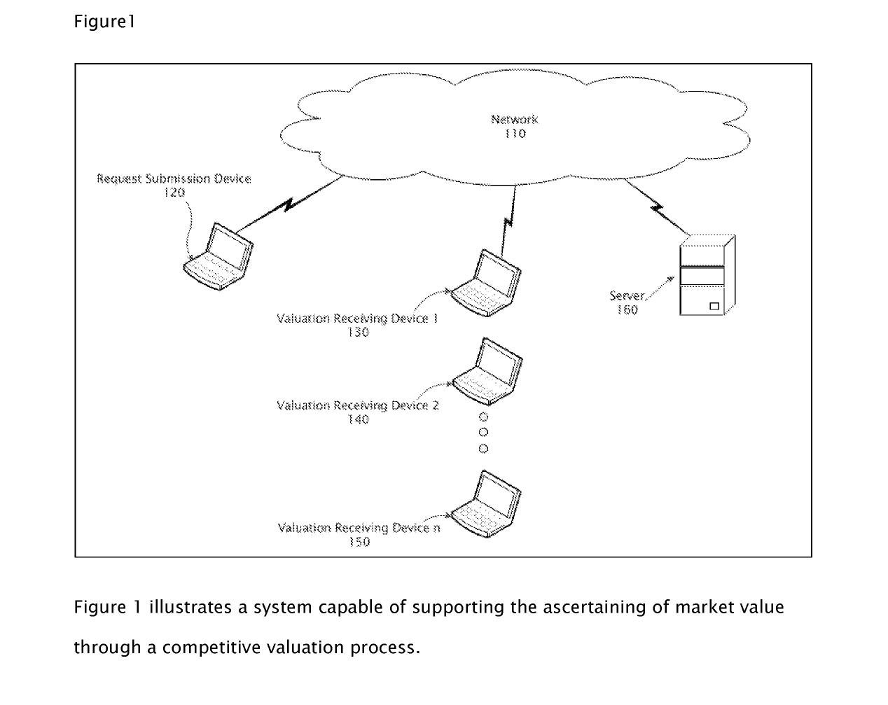

FIG. 1 illustrates a system capable of supporting the ascertaining of market value through a competitive valuation process.

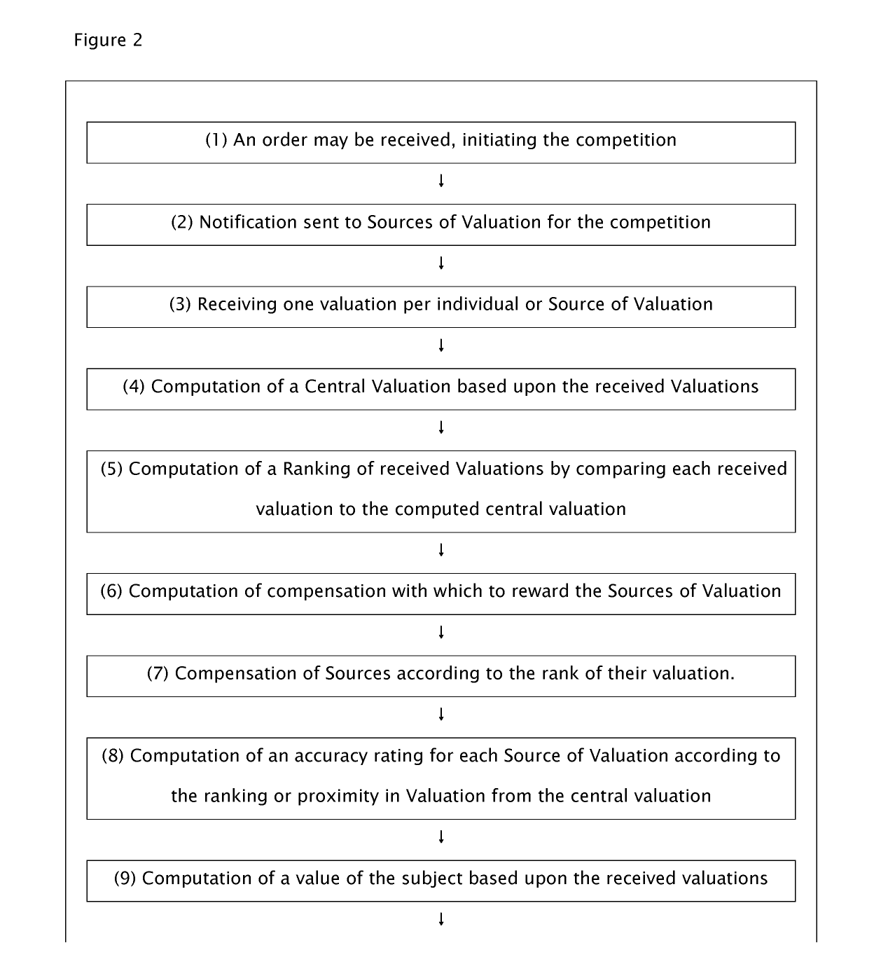

FIG. 2 illustrates, by flowchart, the steps of one embodiment of ascertaining market value through a competitive valuation process.

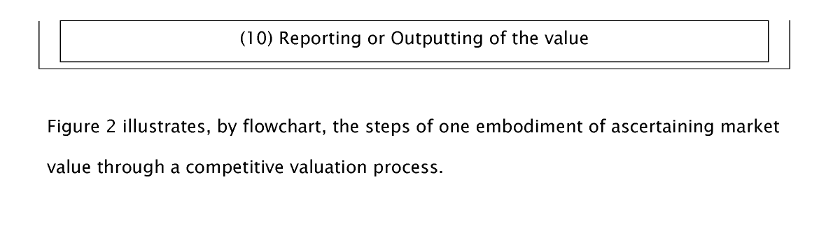

FIG. 3 illustrates one example of possible distributions of compensation to Sources of Valuation when ascertaining market value through a competitive valuation process.

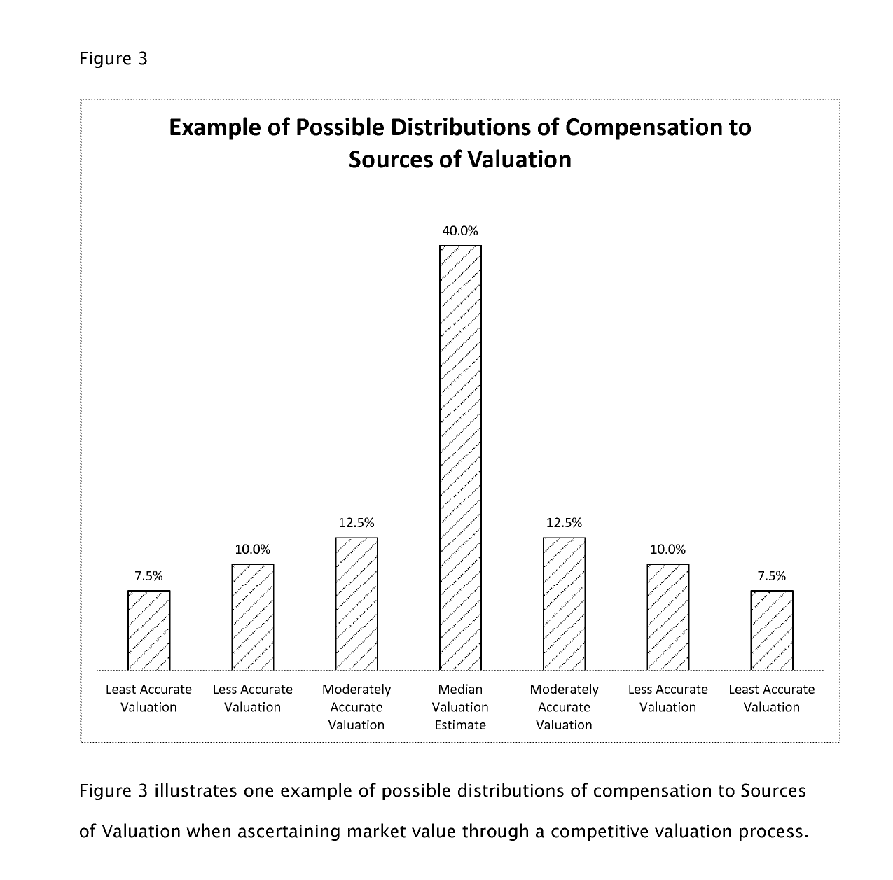

FIG. 4 illustrates, by component diagram, a computing device according to one embodiment.

### DESCRIPTION OF THE PREFERRED EMBODIMENT

Reference will now be made in detail to one or more embodiments. Like reference numbers will reference to like references.

FIG. 1 is a system capable of supporting the ascertaining of market value through a competitive valuation process.

The Network (110) of FIG. 1 may use standard communications protocols to exchange data between a Request Submission Device, Response devices, and the Server (160).

The Request Submission Device (120) of FIG. 1 may be used by a customer to place an order or request for Valuation of a subject. The receiving of this placed order can also be seen in step 1 of FIG. 2. This device is a tangible and concrete form of hardware which may be like that denoted in FIG. 4 as computing device (1300).

The Valuation Receiving Devices 130-150 of FIG. 1 may be used to present notification of new competitions which may be sent by the Server (160), as seen in step 2 of FIG. 2 to the Sources of Valuation. The Valuation Receiving Devices are also utilized by Server (160) to accept a Valuation from each competing Source of Valuation. This device may utilize the Valuation Receiving Component. This Valuations Receiving Device is a tangible and concrete form of hardware which may be like that denoted in FIG. 4 as computing device (1300).

The Server (160) of FIG. 1 may be a tangible and concrete form of hardware which utilizes the tangible hardware of the computing device 1300 of FIG. 4 to execute one or more of commands, including, but not limited to those which create new and meaningful data from existing data, and do so while employing the; valuation receiving component, central valuation component, ranking component, compensation computing component, value computing component, and output component.

These components which may execute upon the computing device 1300 of FIG. 4 support at least one meaningful computing process selected from the list of: computing a central valuation based upon the received valuations, computing a ranking of the received valuations by comparing the proximity of each received valuation to central valuation, and computing a value for a specific subject based upon a plurality of received valuations.

FIG. 2 illustrates, by flowchart, the steps of one embodiment of ascertaining market value through a competitive valuation process. One or more of the steps of the flowchart of FIG. 2 may be implemented through the utilization of one or more computing device (1300), computer processes, websites, or software modules described herein, including, for example, but not limited to FIG. 1 devices 110-160 and the Computing Device 1300 of FIG. 4. Performing of the steps of this flowchart in the sequence given may not be required.

In Step (1) of FIG. 2, an order may be received, initiating the competition. This is the beginning of the process where a valuation order may be received from a customer. This customer may utilize the Request Submission Device 120 of FIG. 1. This request may also be known as a purchase or order. When submitting the request, the Request Submission Device may work in conjunction with a website. The website may have a user interface with a Valuation Receiving Component. This Valuation Receiving Component and user interface may execute upon the memory (1304) and processor (1302) of a computing device (1300) of FIG. 4.

This Valuation Receiving Component and user interface may work in conjunction with the server (160) of FIG. 1. Upon receiving the request, the details of the order may be utilized by the Website, Server (160), and Database, all of which may utilize the computing device, tangible processor (1302) and memory (1304) hardware, by an allocation component, to allocate or denote which Sources of Valuation would be most appropriately fit to the competition. The criteria for selection may include geography, subject categorization, and the overall average Accuracy Rating of each Source of Valuation.

For example, if the subject is a piece of real estate located at a specific location, then real estate agents or appraisers in the zip code of that property may be denoted for notification. If the subject is a patent and therefore categorized as intellectual property, then the appropriate professionals in that industry, and perhaps subcategory, may be denoted for notification.

Also, this Website, Server (160), and Database, all of which may utilize the computing device (1300), tangible processor (1302) and memory (1304) hardware, may hold other information associated with the request. This may include but is not limited to contact information, request details, logon information, payment information, and associated data.

The Website, Server (160), and Database, all of which may utilize the computing device (1300), tangible processor (1302) and memory (1304) hardware, may also be linked to an information providing platform which may supply information to the database regarding the item which is to be evaluated. For example if it is an order for the valuation of a real estate subject property, then it may be linked to information such as address, size, or tax parcel number. If the valuation order is for the valuation of an Intellectual property subject item, then a database may be linked to information on the USPTO website.

In step (2) of FIG. 2 the Website, Server (160), and Database, all of which may utilize the computing device (1300), tangible processor (1302) and memory (1304) hardware, may send notification to the Sources of Valuation of the competition. This notification may be sent to the Sources of Valuation which were allocated or denoted in step (1). Some of those Sources will have higher accuracy ratings than others in accordance with an accuracy rating that may have been determined after past valuation competitions. Within this step a function may be employed, wherein those Sources of Valuation with higher accuracy ratings may be notified proportionately more promptly than those with lower accuracy ratings.

Also, sources of Valuation may be informed of the competitive characteristic of the process. This information may include the concept that submitting valuation submissions which are more central within the estimates of the group will result in higher compensation, higher accuracy ratings, or prompter notification of future valuation competitions. In this notification may also be information that only a limited number of valuation opportunities will be available in the valuation competition. The goal of this information would be to induce promptness, and may not be included in every valuation competition.

Source of Valuation may then evaluate the Subject by a specified or unspecified method. This method may potentially include subjective methods. The method of Valuation may depend significantly on the industry or the subject matter of the item being valued.

A benefit of this system is that the value or set of values, found by the system, may be surrounded and supported by the submitted valuations which may extend credence to the value. The value is supported and the Sources of Valuation are appropriated through the integration of multiple competing professionals.

This characteristic of the system and method of integrating multiple competitive valuations will likely alleviate some of the pressure to confine the valuation professional to a specific set of prescribed, recorded, and monotonous steps. It is these monotonous steps which make the process of valuing an asset time consuming and expensive, all the while not necessarily providing a more accurate or timely valuation.

Furthermore, if this alleviation is significant enough, then some latitude will be allowed for Sources of Valuation to include more subjective characteristics in their valuations. This is would be a desirable characteristic in many industries.

In step (3) of FIG. 2 the Website, Server (160), and Database, all of which may utilize the computing device (1300), tangible processor (1302) and memory (1304) hardware, may be utilized, through the Response Devices 1-n (130-150) of FIG. 1, to allow the Valuation Receiving Component to receive from the Sources of Valuation each of their valuation opinions.

It should also be noted that the Sources of Valuation may each submit a valuation without knowing the valuation opinions of other Sources. The goal of this withholding of information is to force the Sources of Valuation to be as accurate as possible when submitting their own valuation. Also, Sources of Valuation may be placed under a time constraint when submitting their valuation. The goal of this time constraint may be to motivate more rapidness. This may be accomplished when the number of valuation competitors is limited to be less than those who wish to compete.

In step (4) of FIG. 2 the Website, Server (160), and Database, all of which may utilize the computing device (1300), tangible processor (1302) and memory (1304) hardware, by utilizing the Central Valuation Computing Component, may compute a Central Valuation based upon the received Valuations. This Central Valuation may be computed using a mathematical measure of central tendency such as the mathematical average, median, mode, or standard deviation.

In step (5) of FIG. 2 the Website, Server (160), and Database, all of which may utilize the computing device (1300), tangible processor (1302) and memory (1304) hardware, through a Ranking Component, may compute a Ranking of received Valuations by comparing each received valuation to the computed central valuation.

In step (6) of FIG. 2 the Website, Server (160), and Database, all of which may utilize the computing device (1300), tangible processor (1302) and memory (1304) hardware, by the Compensation Computing Component, may compute the compensation due to each Source of Valuation according to the placement of their Valuation within the Ranking.

In step (7) the Sources of Valuation may be compensated according to compensation computed. Sources of Valuation are notified of the rank of their Valuation and the compensation they are to receive. Sources of Valuation are compensated in a diversity of ways including, but are not limited to, financial payments, an increased accuracy rating, and future valuation opportunities.

In step (8) the Website, Server (160), and Database, all of which may utilize the computing device (1300), tangible processor (1302) and memory (1304) hardware, may compute an accuracy rating for each Source of Valuation according to the ranking or proximity in Valuation from the central valuation. Those Sources who had valuations that were very accurate may have a rating increased, and those with inaccurate, less central, Valuations will see their scores decreased. Accuracy is measured as proximity or distance to the median, mean, or some other measure of central tendency. The amounts that these accuracy scores will be adjusted will follow a preset schedule or mathematical function. The accuracy score may employ a weighted average, summation, or another method. It may be based on the sum of proximities to final valuations, rankings of the competitions, or other determining factors.

Also, a function may be employed wherein over multiple valuation competitions those Sources of Valuation with significantly lower accuracy ratings are notified of future valuation requests in a more delayed fashion. Furthermore, continued inaccuracy may conclude in the exclusion of Source of Valuation from participation in future valuation competitions. In this way, the process will naturally select those Sources of Valuation who are more accurate over multiple valuations.

In Step (9) the Website, Server(160), and Database, all of which may utilize the computing device (1300), tangible processor (1302) and memory (1304) hardware, by the Value Computing Component, may compute a value of the subject based upon the received valuations. This value may be retrieved from the Central Valuation computed in Step 4 or it may be computed according to computation from a subset of submitted valuations.

In Step (10) the Website, Server (160), and Database, all of which may utilize the computing device (1300), tangible processor (1302) and memory (1304) hardware, by an Output Component configured to output the computed value, may output the value. The valuations, a subset, the computed value and supporting information may then be sent to the customer. This information is sent to the customer in a format appropriate to the subject matter or customer. For example, in real estate valuations the format may look much like a standard appraisal document, and in the review of employees the data may be transferred according to required data transfer techniques.

FIG. 3 illustrates one example of possible distributions of compensation to Sources of Valuation when ascertaining market value through a competitive valuation process. The distribution seen in FIG. 3 would be computed in accordance with step 6 of FIG. 2 which may be implemented on one or more computing device (1300), computer processes, or software modules described herein, including, for example, but not limited to the Compensation Computing Component.

In the example of FIG. 3 more central, or more accurate, submitted valuations are compensated with a higher percent of the total compensation. Notice also that here there are seven Sources of Valuation, but this is not meant to be a limiting characteristic, the number of Sources of Valuation must only be plural. Also, the compensation paid to the Evaluators may not always fit the percentages shown in the figure. They may range quite differently.

FIG. 4 illustrates, by component diagram, a computing device (1300) according to one embodiment. The computing device (1300) can be utilized to implement one or more computing device (1300), computer processes, or software modules described herein, including, for example, but not limited to the Request Submission Device of FIG. 1. In one example, the computing device (1300) can be utilized to process calculations, execute instructions, receive and transmit digital signals. In another example, the computing device (1300) can be utilized to process calculations, execute instructions, receive and transmit digital signals, receive and transmit search queries, and hypertext, compile computer code as required by a User Device 110, 120 or a Content Manager 140. The computing device (1300) can be any general or special purpose computer now known or to become known capable of performing the steps and/or performing the functions described herein, either in software, hardware, firmware, or a combination thereof.

In its most basic configuration, computing device (1300) typically includes at least one processor (1302) or central processing unit (CPU) (1302) and memory (1304). Depending on the exact configuration and type of computing device (1300), memory (1304) may be volatile (such as RAM), non-volatile (such as ROM, flash memory, etc.) or some combination of the two. Additionally, computing device (1300) may also have additional features/functionality. For example, computing device (1300) may include multiple CPU's. The described methods may be executed in any manner by any processor (1302) or processing unit in computing device (1300). For example, the described process may be executed by both multiple CPU's in parallel.

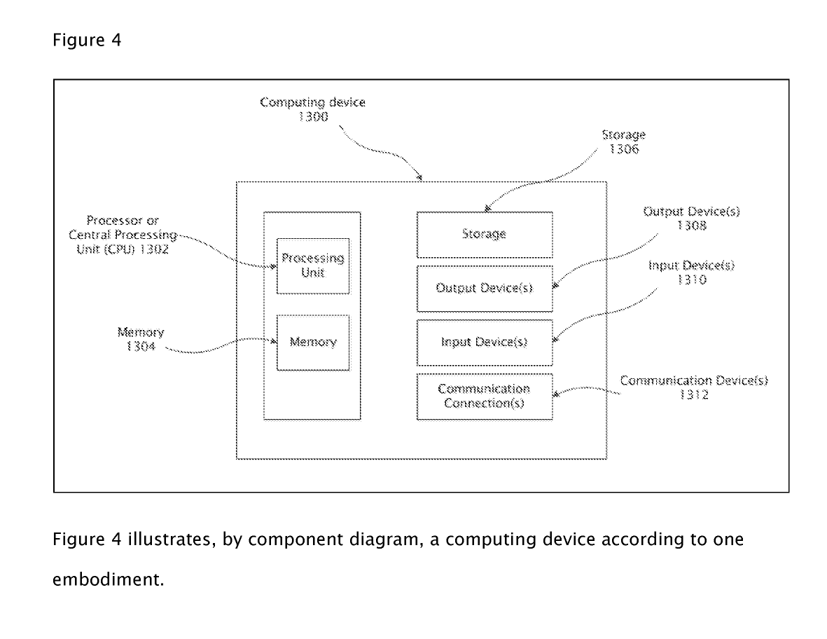

Computing device (1300) may also include additional storage (removable and/or non-removable) including, but not limited to, magnetic or optical disks or tape. Such additional storage is illustrated in FIG. 8 by storage (1306). Computer storage media includes volatile and nonvolatile, removable and non-removable media implemented in any method or technology for storage of information such as computer readable instructions, data structures, program modules or other data. Memory (1304) and storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing device (1300) may also contain communications device(s) (1312) that allow the device to communicate with other devices. Communications device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device (1300) may also have input device(s) (1310) such as keyboard, mouse, pen, voice input device, touch input device, etc. Output device(s) (1308) such as a display, speakers, printer, etc. may also be included. All these devices are well known in the art and need not be discussed at length.

Those skilled in the art will realize that storage devices utilized to store program instructions can be distributed across a network (110). For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processor (1302) or processing unit (1302) or by distributed processors (1302) or processing units (1302).

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1) A computer readable storage medium containing instruction thereon which, when executed upon a processor, perform a method comprising:
a) computing, an allocation that identifies sources of valuation;
b) receiving a valuation from each of a plurality of identified sources for a specific subject;
c) computing a central valuation based upon the received valuations;
d) computing a ranking of the received valuations by comparing the proximity of each received valuation to the central valuation;
e) compensating the sources of valuations based on the ranking of the valuation each provider provided;
f) computing a value for the specific subject based upon a plurality of the received valuations; and
g) outputting the computed value.

2) The method of claim 1 wherein the specific subject is selected from the group comprising: real property, personal property, collectibles, currency, intangible property, intellectual property, businesses, opportunities, strengths, weaknesses, risks, financial securities, employees, employees skills, employees weaknesses, professors, coworkers, salaries, budgets, forecasts, construction projects, explorations for natural resources, probabilities.

3) The method of claim 1 wherein the sources of valuations are selected from the group comprising: individuals, professionals, the general public, automated methods of estimating value, neural networks, expert systems, knowledge based systems, generally accepted accounting principles, accounting based valuations systems, sales approaches, cost approaches, hedonic approaches, repeat sales approaches, objective approaches, subjective approaches, hybrid approaches, and appraisal systems.

4) The method of claim 1 wherein the central valuation is computed using a function selected from the group comprising: standard deviation, average, median, mode, and range.

5) The method of claim 1 wherein compensating is selected from the group comprising: financial payments, improved accuracy ratings, and future valuation transactions.

6) The method of claim 1 wherein the value is computed using a function selected from the group comprising: standard deviation, average, median, mode, and range.

7) A system comprising:
a) a processor;
b) a memory coupled to the processor;
c) a website having a user interface executing upon the processor;
d) an allocation component configured to allocate sources of valuation;
e) a valuation receiving component configured to receive, from providers, valuations of a specific subject, via the website user interface, each valuation associated with a provider;
f) a central valuation computing component configured to compute a central valuation base upon the received valuations;
g) a ranking component configured to rank the received valuations based upon comparing the proximity of each valuation to the central valuation;
h) a compensation computing component configured to compute compensation for a provider based upon the ranking of the associated valuation;
i) a value computing component configured to compute a value based upon a plurality of received valuations; and
j) An output component configured to output the computed value.

8) The System of claim 7, wherein the specific subject is selected from the group comprising: real property, personal property, collectibles, currency, intangible property, intellectual property, businesses, opportunities, strengths, weaknesses, risks, financial securities, employees, employees skills, employees weaknesses, professors, coworkers, salaries, budgets, forecasts, construction projects, explorations for natural resources, probabilities.

9) The System of claim 7, wherein the providers of valuations are selected from the group comprising: individuals, professionals, the general public, automated methods of estimating value, neural networks, expert systems, knowledge based systems, generally accepted accounting principles, accounting based valuations systems, sales approaches, cost approaches, hedonic approaches, repeat sales approaches, objective approaches, subjective approaches, hybrid approaches, and appraisal systems.

10) The System of claim 7, wherein the central valuation is computed using a function selected from the group comprising: standard deviation, average, median, mode, and range.

11) The System of claim 7, wherein the sources of compensation is selected from the group comprising: financial payments, improved accuracy ratings, and future valuation transactions.

12) The System of claim 7, wherein the value is computed using a function selected from the group comprising: standard deviation, average, median, mode, and range.

13) A computing-device-implemented method comprising:
a) Computing an allocation that identifies sources of valuation;
b) receiving a valuation from each of a plurality of identified sources for a specific subject;
c) computing a central valuation based upon the received valuations;
d) computing a ranking of the received valuations by comparing the proximity of each received valuation to the central valuation;
e) compensating the sources of valuations based on the ranking of the valuation each provider provided;
f) computing a value for the specific subject based upon a plurality of the received valuations;
g) outputting the computed value; and
h) wherein at least one of the computing steps of the method is executed on a computing device.

14) The method of claim 13 wherein the specific subject is selected from the group comprising: real property, personal property, collectibles, currency, intangible property, intellectual property, businesses, opportunities, strengths, weaknesses, risks, financial securities, employees, employees skills, employees weaknesses, professors, coworkers, salaries, budgets, forecasts, construction projects, explorations for natural resources, probabilities.

15) The method of claim 13 wherein the sources of valuations are selected from the group comprising: individuals, professionals, the general public, automated methods of estimating value, neural networks, expert systems, knowledge based systems, generally accepted accounting principles, accounting based valuations systems, sales approaches, cost approaches, hedonic approaches, repeat sales approaches, objective approaches, subjective approaches, hybrid approaches, and appraisal systems.

16) The method of claim 13 wherein the central valuation is computed using a function selected from the group comprising: standard deviation, average, median, mode, and range.

17) The method of claim 13 wherein compensating is selected from the group comprising: financial payments, improved accuracy ratings, and future valuation transactions.

18) The method of claim 13 wherein the value is computed using a function selected from the group comprising: standard deviation, average, median, mode, and range.
